(19) United States
(12) Patent Application Publication
(10) Pub. No.: US 2008/0047897 A1
(43) Pub. Date: Feb. 28, 2008

(54) METHOD OF RECYCLING WASTE WATER AND APPARATUS FOR PERFORMING THE SAME

(75) Inventors: In-Ho Jeong, Gyeonggi-do (KR); Jae-Dong Hwang, Gyeonggi-do (KR); Sung-Kwang Eun, Gyeonggi-do (KR); Byung-Moon Choi, Gyeonggi-do (KR); Sun-Pil Kim, Gyeonggi-do (KR); Deung-Yoon Heo, Seoul (KR)

Correspondence Address: MARGER JOHNSON & MCCOLLOM, P.C., 210 SW MORRISON STREET, SUITE 400, PORTLAND, OR, 97204, US

(73) Assignees: SAMSUNG ELECTRONICS CO., LTD., Gyeonggi-do (KR); SAMSUNG ENGINEERING CO., LTD., Seoul (KR)

(21) Appl. No.: 11/840,187

(22) Filed: Aug. 16, 2007

(30) Foreign Application Priority Data
Aug. 24, 2006 (KR) 2006-0080171

(51) Int. Cl. C02F 9/00; C02F 9/02; C02F 9/04

(52) U.S. Cl. 210/636; 210/188; 210/638; 210/639; 210/652

(57) ABSTRACT

A method of recycling waste water is preferably provided in which hardness and gas are removed from the waste water. Additionally, salt and organic carbon are preferably removed from the waste water using high-efficiency reverse osmosis. The pH of the waste water can be controlled to optimize the processes. The recycled semiconductor waste water can then be made available for use as industrial water for performing a semiconductor fabrication process. As a result, a cost for manufacturing a semiconductor device may be reduced. The principles of the present invention also provide a more environmentally friendly manufacturing method, since it produces less semiconductor waste water when being performed than conventional methods.

### CROSS-REFERENCE TO RELATED APPLICATIONS

This application claims priority under 35 USC § 119 from Korean Patent Application No. 2006-80171 filed on Aug. 24, 2006, the contents of which are herein incorporated by reference in their entirety for all purposes.

### BACKGROUND OF THE INVENTION

1. Field of the Invention

The present invention relates generally to a method and apparatus for recycling waste water. More particularly, the present invention relates to a method and apparatus for removing noxious components from semiconductor waste water to enable its reuse.

2. Description of the Related Art

Semiconductor devices are typically manufactured through a deposition process, a photolithography process, an ion implantation process, a polishing process, a cleaning process, and other processes. Various chemicals are used during these semiconductor manufacturing processes that generate noxious components that contaminate the semiconductor waste water. The semiconductor waste water may therefore include, for instance, organic carbon, bio-fouling, suspended solid, fluorine ions, and other contaminants.

According to conventional semiconductor manufacturing methods, after removing noxious components from the semiconductor waste water, the semiconductor waste water may not be recycled at all. Thus, the semiconductor waste water may be completely or nearly completely discharged. As a result, a semiconductor device may need to be manufactured using only new industrial water, thereby resulting in an increased cost of manufacturing.

### SUMMARY OF THE INVENTION

According to various principles of the present invention, a method and apparatus for recycling semiconductor waste water are provided.

A method of recycling waste water in accordance with one aspect of the present invention preferably begins by removing hardness from the waste water. A gas can then be removed from the waste water. Finally, salt and organic carbon can be removed from the waste water using a high-efficiency reverse osmosis process.

According to another aspect of the present invention, before removing the hardness, a disinfectant may be put into the waste water to remove microbes from the waste water. The disinfectant may include sodium hypochlorite (NaOCl).

According to another aspect of the present invention, removing the hardness may include passing the waste water through an ion exchange resin to remove calcium (Ca) and magnesium (Mg) from the waste water. The ion exchange resin may include a weak acid cation resin. Removing the hardness may further include putting a neutralizing agent into the waste water to prevent an oxidation of the ion exchange resin. The neutralizing agent may include sodium bisulfate. Removing the hardness may also include putting a first pH-controlling agent into the waste water to provide the waste water with a pH of between about 8.5 to about 9.5. The first pH-controlling agent may include sodium hydroxide (NaOH). Additionally, removing the hardness may further include putting an anti-scale agent into the waste water. The anti-scale agent may include hydrogen chloride (HCl).

According to another aspect of the present invention, removing the gas may include removing a carbonic acid gas from the waste water. Removing the carbonic acid gas may include putting a second pH-controlling agent into the waste water to provide the waste water with a pH of between about 2 to about 3. The second pH-controlling agent may include hydrogen chloride (HCl).

According to a still further aspect of the present invention, removing the salt and the organic carbon may include putting a third pH-controlling agent into the waste water to provide the waste water with a pH of no less than about 10. The third pH-controlling agent may include sodium hydroxide (NaOH).

A method of recycling semiconductor waste water according to another embodiment of the present invention begins by placing sodium hydroxide (NaOH) into the semiconductor waste water to provide the semiconductor waste water with a pH of between about 8.5 to about 9.5. The semiconductor waste water then passes through a weak acid cation ion exchange resin to remove calcium (Ca) and magnesium (Mg) from the semiconductor waste water. Hydrogen chloride (HCl) is then added to the semiconductor waste water to provide the semiconductor waste water with a pH of between about 2 to about 3. A carbonic acid gas can then be removed from the semiconductor waste water. Sodium hydroxide (NaOH) is again put into the waste water to provide the semiconductor waste water with a pH of no less than about 10. Salt and organic carbon can then be removed from the waste water using high-efficiency reverse osmosis.

An apparatus for recycling waste water in accordance with still another embodiment of the present invention preferably includes a hardness removing unit, a gas removing unit, and a high-efficiency reverse osmosis unit. The hardness-removing unit is preferably configured to remove hardness from the waste water. The gas-removing unit can be connected to the hardness-removing unit to receive the waste water from the hardness-removing unit and can be configured to remove gas from the waste water. The high-efficiency reverse osmosis unit is preferably connected to the gas-removing unit to receive the waste water from the gas-removing unit and can be configured to remove salt and organic carbon from the waste water.

According to other aspects of the present invention, the apparatus may further include a disinfectant line for adding a disinfectant to the waste water to remove microbes from the waste water. The disinfectant line can be connected to a pipe through which the waste water is introduced into the hardness removing unit. The hardness-removing unit may include a weak acid cation ion exchange resin for removing calcium (Ca) and magnesium (Mg) from the waste water. The apparatus may further include a neutralization line for adding a neutralizing agent, which prevents oxidation of the ion exchange resin, into the hardness removing unit. A first pH control line can be included to add a first pH-controlling agent, which provides the waste water with a pH of between about 8.5 about 9.5, into the hardness removing unit. And an anti-scale line can be configured to introduce an anti-scale agent, which prevents scales from being formed on an inner wall of the pipe, into the hardness removing unit.

The apparatus may further include a second pH control line for putting a second pH-controlling agent, which provides the waste water with a pH of between about 2 to about 3, into the gas removing unit. A third pH control line can also be provided for putting a third pH-controlling agent, which provides the waste water with a pH of no less than about 10, into the reverse osmosis unit. The apparatus may also include a first bath for storing the waste water before it is supplied to the hardness removing unit, a second bath for storing waste water received from the hardness-removing unit, a third bath for storing waste water received from the gas removing unit, and a fourth bath for storing waste water received from the reverse osmosis unit.

In another embodiment, the hardness may be removed from the waste water after the waste water is provided with a pH of between about 8.5 to about 9.5 using sodium hydroxide (NaOH). In this manner, calcium and magnesium may be easily removed from the waste water. The carbonic acid gas may then be removed from the waste water after the waste water is provided with a pH of between about 2 to about 3 using hydrogen chloride (HCl). At this pH level, carbonic acid gas may be easily removed from the waste water. Furthermore, salt and organic carbon may be removed from the waste water using reverse osmosis when the waste water is provided with a pH of no less than about 10. In this way, the efficiency of the cleaning process by which suspended solids and organic matters are removed from the waste water may be improved.

### BRIEF DESCRIPTION OF THE DRAWINGS

The above and other features and advantages of the invention will become more readily apparent through the following detailed description made with reference to the accompanying drawings, wherein:

FIG. 1 is a schematic block diagram illustrating an apparatus for recycling waste water in accordance with one embodiment of the present invention;

FIG. 2 is a flow chart illustrating a method of recycling semiconductor waste water using the apparatus shown in FIG. 1;

FIG. 3 is a graph illustrating a removal ratio of noxious components in the waste water in accordance with a pH level of the waste water;

FIG. 4 is a graph illustrating a recover rate of silicon oxide from the waste water in accordance with a pH level of the waste water; and

FIG. 5 is a graph illustrating a total viable bacteria count in the waste water in accordance with a pH level.

### DETAILED DESCRIPTION

The principles of the present invention will now be described more fully with reference to various preferred embodiments thereof. It should be noted, however, that this invention may be embodied in many different forms and should therefore not be construed as being limited to the specific embodiments set forth herein. Rather, these embodiments provide an enabling disclosure and satisfy the best mode requirement to fully convey the scope of the invention to those skilled in the art. In the drawings, the size and relative sizes of layers and regions may be exaggerated for clarity. Like numbers refer to like elements throughout.

It should also be understood that when an element or layer is referred to as being “on,” “connected to” or “coupled to” another element or layer, it can be arranged directly on or directly connected or coupled to the other element or layer, or additional intervening elements or layers may be present. When an element is referred to as being “directly on,” “directly connected to” or “directly coupled to” another element or layer, however, there are no intervening elements or layers present. As used herein, the term “and/or” includes any and all combinations of one or more of the associated listed items.

It should further be understood that although the terms first, second, etc. may be used herein to describe various elements, components, regions, layers and/or sections; these elements, components, regions, layers and/or sections are not limited by these terms. Rather, these terms are only used to distinguish one element, component, region, layer, or section from another region, layer, or section. Thus, a first element, component, region, layer, or section discussed below could be termed a second element, component, region, layer or section without departing from the teachings of the present invention.

In addition, spatially relative terms, such as “beneath,” “below,” “lower,” “above,” “upper,” and the like, may be used herein for ease of description to describe one element or feature's relationship to another element(s) or feature(s) as illustrated in the figures. It will be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein are to be interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Apparatus for Recycling Waste Water

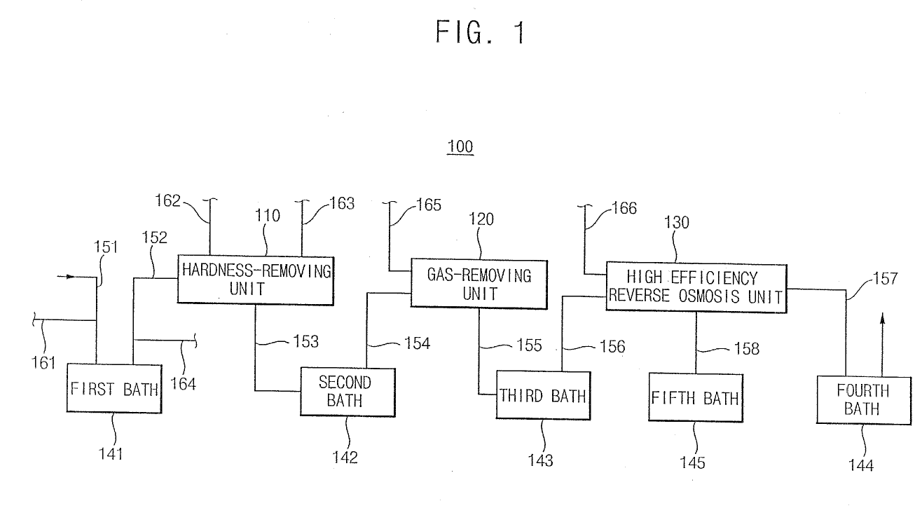

An apparatus for recycling waste water will now be described in more detail with reference to the attached drawings. FIG. 1 is a schematic block diagram illustrating an apparatus 100 for recycling waste water in accordance with one exemplary embodiment incorporating principles of the present invention. Referring to FIG. 1, an apparatus 100 for recycling waste water preferably includes a hardness removing unit 110, a gas removing unit 120, and a high-efficiency reverse osmosis unit 130. The apparatus 100 may further include a first bath 141, a second bath 142, a third bath 143, a fourth bath 144, and a fifth bath 145. A first line 161, a second line 162, a third line 163, a fourth line 164, a fifth line 165, and a sixth line 166 can also be included.

More specifically, a first pipe 151 is preferably connected to the first bath 141 to supply semiconductor waste water to the first bath 141. The semiconductor waste water may include calcium, magnesium, carbonic acid gas, salt, organic carbon, fluorine ions, etc. The first line 161 is preferably connected to the first pipe 151 to supply a disinfectant into the first pipe 151. The disinfectant preferably removes microbes from the semiconductor waste water. The disinfectant may, for instance, include sodium hypochlorite (NaOCl).

The first bath 141 is preferably connected to the hardness removing unit 110 through a second pipe 152. The fourth line 164 can be connected to the second pipe 152. An anti-scale agent is preferably supplied to the second pipe 152 through the fourth line 164 to prevent scales, which may otherwise be generated as the semiconductor waste water passes through the second pipe 152, from being formed on an inner wall of the second pipe 152. In particular, the carbonic acid gas and the calcium in the semiconductor waste water passing through the second pipe 152 chemically react with each other to form calcium carbonate (CaCO₃). Without an anti-scale agent, the calcium carbonate (CaCO₃) may adhere to the inner wall of the second pipe 152 to form scales. The anti-scale agent prevents the chemical bonding between the carbonic acid gas and the calcium and thereby prevents the formation of scales. The anti-scale agent may, for instance, include hydrogen chloride (HCl).

The hardness removing unit 110 may include a weak acid cation ion exchange resin. The weak acid cation ion exchange resin preferably removes the calcium and the magnesium that may act to form the scales in the semiconductor waste water. To do this, the weak acid cation ion exchange resin may have an ester (COO⁻) group. The ester (COO⁻) group is ion-exchanged for calcium ions or magnesium ions to remove only the calcium and the magnesium from the semiconductor waste water.

The second line 162 is preferably connected to the hardness removing unit 110. A neutralizing agent can be supplied to the hardness removing unit 110 through the second line 162 to prevent oxidation of the weak acid cation ion exchange resin due to acid components in the semiconductor waste water. The neutralizing agent may include sodium bisulfate (NaHSO₄).

The third line 163 is also preferably connected to the hardness removing unit 110. When the semiconductor waste water has a pH below about 8.5, the efficiency of the process for removing the calcium and the magnesium using the weak acid cation ion-exchange region may be decreased. Therefore, a first pH-controlling agent is preferably supplied through the third line 163 to provide the semiconductor waste water in the hardness removing unit 110 with a pH of between about 8.5 to about 9.5. The first pH-controlling agent may, for example, include sodium hydroxide (NaOH).

The hardness removing unit 110 and the second bath 142 are preferably connected to each other through a third pipe 153. The semiconductor waste water, having had the hardness removed by the hardness removing unit 110, is then supplied to the second bath 142 through the third pipe 153.

The second bath 142 and the gas removing unit 120 are preferably connected to each other through a fourth pipe 154. The gas removing unit 120 functions to remove gases from the semiconductor waste water. The gas removing unit 120 can, for instance, remove the carbonic acid gas from the semiconductor waste water to prevent a chemical reaction between the carbonic acid gas and the calcium, thereby also preventing calcium carbonate (CaCO₃) from being formed. To perform this function, the gas removing unit 120 may include a filter having a minute meshed structure through which the semiconductor waste water passes. An air generator can also be provided to supply upwardly blowing air into the filter. After the semiconductor waste water passes through the minute meshed filter, the semiconductor waste water may have an enlarged area. By supplying a large amount of air upwardly to the semiconductor waste water spread around the enlarged area, the gases in the semiconductor waste water can be upwardly released.

Here, since carbon dioxide (CO₂) gas has a molecular weight lighter than that of carbon trioxide (CO₃) gas, the carbon dioxide (CO₂) gas can be more easily removed as compared to carbon trioxide (CO₃) gas. Therefore, it is desirable to convert the carbon trioxide (CO₃) gas into carbon dioxide (CO₂) gas. To do this, a second pH-controlling agent is preferably put into the gas removing unit 120 through the fifth line 165 to lower a pH of the semiconductor waste water. The second pH-controlling agent may, for example, provide the semiconductor waste water in the gas removing unit 120 with a pH of between about 2 to about 3. The second pH-controlling agent may include hydrogen chloride (HCl).

The third bath 143 is preferably connected to the gas-removing unit 120 through a fifth pipe 155. The degasified semiconductor waste water is stored in the third bath 143. The third bath 143 is also preferably connected to the high-efficiency reverse osmosis unit 130 through a sixth pipe 156.

The high-efficiency reverse osmosis unit 130 removes the salt and the organic carbon from the semiconductor waste water using reverse osmosis. In particular, the high-efficiency reverse osmosis unit 120 removes the salt and the organic carbon from the semiconductor waste water using a semi-permeable membrane by moving a solvent in a solution having a high concentration toward a solution having a low concentration. When the semiconductor waste water has a pH of no less than about 10, the efficiency of the reverse osmosis process in the high-efficiency reverse osmosis unit 130 may be optimized. More specifically, a pH of no less than about 10 permits organic carbon, silicon, sodium, chlorine, sulfur, boron, and other contaminants in the semiconductor waste water to be more easily charged with a negative ion. The negatively charged components may then be readily removed using the reverse osmosis process. To obtain the appropriate pH level, a third pH-controlling agent can be put into the high-efficiency reverse osmosis unit 130 through the sixth line 166. The third pH-controlling agent thereby provides the semiconductor waste water being supplied into the high-efficiency reverse osmosis unit 130 with a pH of no less than about 10. The third pH-controlling agent may include sodium hydroxide (NaOH).

After the semiconductor waste water passes through the high-efficiency reverse osmosis unit 130, the semiconductor waste water may be converted into industrial water for use in the semiconductor fabrication processes. The industrial water is preferably supplied to the fourth bath 144 through a seventh pipe 157. The industrial water can then be stored in the fourth bath 144 until it is needed for the semiconductor fabrication process.

Alkaline drain water generated in the high-efficiency reverse osmosis unit 130 can be transferred to the fifth bath 145 through an eighth pipe 158. The alkaline drain water can be stored in the fifth bath 145.

Method of Recycling Waste Water

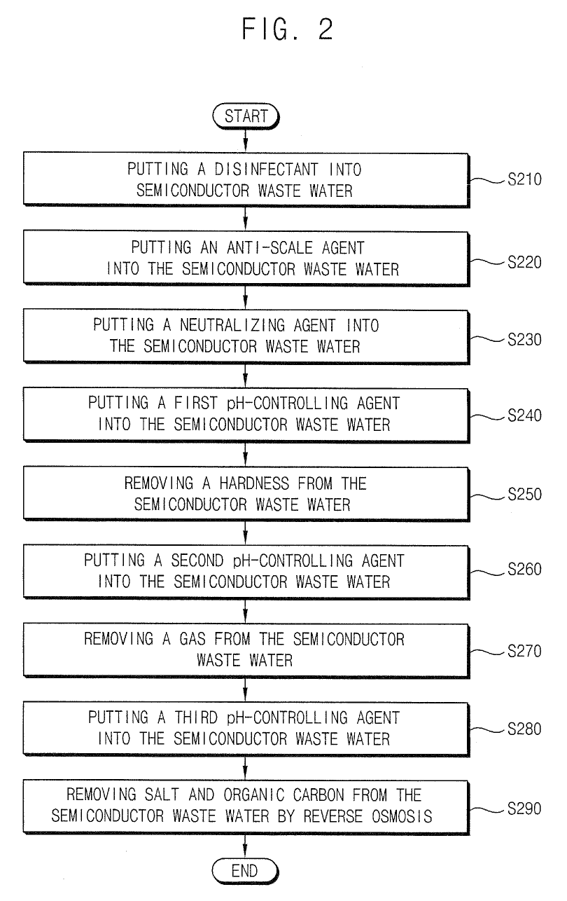

A method of recycling waste water in a semiconductor fabrication process according to principles of the present invention will now be described in greater detail. FIG. 2 is a flow chart illustrating a method of recycling semiconductor waste water using the apparatus shown in FIG. 1 according to one embodiment incorporating principles of the present invention. Referring to FIGS. 1 and 2, in a first step S210, sodium hypochlorite (NaOCl) is preferably put into the first pipe 151 through the first line 161. The sodium hypochlorite (NaOCl) acts as a disinfectant to remove microbes from the semiconductor waste water passing through the first pipe 151. The disinfected semiconductor waste water is then transferred to and stored in the first bath 141.

In step S220, the semiconductor waste water in the first bath 141 is supplied to the hardness removing unit 110 through the second pipe 152. An anti-scale agent (e.g., hydrogen chloride (HCl)) can be supplied to the second pipe 152 through the fourth line 164. The hydrogen chloride (HCl) prevents a chemical reaction between the carbonic acid gas and the calcium to prevent a formation of calcium carbonate (CaCO₃). Thus, the formation of scales, which are created when calcium carbonate (CaCO₃) attaches to the inner wall of the second pipe 152, can be prevented.

In step S230, sodium bisulfate (NaHSO₄) can be put into the hardness removing unit 110 as the neutralizing agent through the second line 162. The neutralizing agent prevents the oxidation of the weak acid cation ion exchange resin due to the acid components in the semiconductor waste water.

In step S240, sodium hydroxide (NaOH) may be put into the hardness removing unit 110 through the third line to act as the first pH-controlling agent. The first pH-controlling agent preferably provides the semiconductor waste water in the hardness removing unit 110 with a pH of between about 8.5 to about 9.5.

In step S250, the semiconductor waste water passes through the weak acid cation ion exchange resin of the hardness removing unit 110 to remove calcium and magnesium from the semiconductor waste water. In particular, the ester (COO⁻) group of the weak acid cation ion exchange resin is ion-exchanged for calcium ions or magnesium ions to remove only the calcium and the magnesium from the semiconductor waste water. When the semiconductor waste water has a pH of between about 8.5 to about 9.5, the calcium and the magnesium can be effectively removed. The semiconductor waste water, from which the hardness has been removed, is then transferred to the second bath 142 through the third pipe 153.

In step S260, the semiconductor waste water stored in the second bath 142 is supplied to the gas-removing unit 120 through the fourth pipe 154. A second pH-controlling agent, such as hydrogen chloride (HCl), for instance, can then be introduced into the gas-removing unit 120 through the fifth line 165. Since carbonic acid gas can be more optimally removed when the semiconductor waste water has a pH of between about 2 to about 3, the second pH-controlling agent preferably provides the waste water in the gas-removing unit 120 with a pH of between about 2 to about 3. More particularly, the hydrogen chloride (HCl) converts carbon trioxide (CO₃) gas into carbon dioxide (CO₂) gas so that the degasification process in the gas-removing unit 120 may be more easily performed.

In step S270, the gas removing unit 120 can effectively remove the carbonic acid gas from the semiconductor waste water. The semiconductor waste water passes through a minute meshed filter, giving the waste water an enlarged area. Then, a large volume of air blows from underneath the enlarged area of the semiconductor waste water, causing the gases in the waste water to be upwardly released. The degasified semiconductor waste water is then supplied to the third bath 143 through the fifth pipe 155. The above-mentioned processes may be referred to as pretreatment of the semiconductor waste water.

In step S280, the pretreated semiconductor waste water is supplied to the high-efficiency reverse osmosis unit 130 through the sixth pipe 156. Sodium hydroxide (NaOH) can then be put into the high-efficiency reverse osmosis unit 130 through the sixth line 166 to operate as a third pH-controlling agent. The third pH-controlling agent preferably provides the semiconductor waste water in the high-efficiency reverse osmosis unit 130 with a pH of no less than about 10.

In step S290, when the waste water pH is no less than about 10, the high-efficiency reverse osmosis unit 130 effectively removes organic carbon, silicon, sodium, chlorine, sulfur, boron, and other contaminants, from the semiconductor waste water. The alkaline drain water generated in the high-efficiency reverse osmosis unit 130 is transferred to the fifth bath 145 through the eighth pipe 158.

The semiconductor waste water processed through the above-mentioned processes can thereby be converted into industrial water that may be used for a semiconductor fabrication process. The industrial water is preferably transferred to the fourth bath 144 through the seventh pipe 157. The industrial water can be stored in the fourth bath 144 until it is needed for a later semiconductor fabrication process.

Using principles of the present invention, waste water hardness may be readily removed when the semiconductor waste water is provided with sodium hydroxide (NaOH) to achieve a pH of between about 8.5 to about 9.5. Furthermore, carbonic acid gas may be readily removed from the semiconductor waste water when hydrogen chloride (HCl) is added to obtain a pH of between about 2 to about 3. Additionally, salt and organic carbon may be effectively removed from the waste water through a reverse osmosis process when the waste water has a pH of no less than about 10. A pH of no less than about 10 improves the efficiency with which suspended solids and organic matters may be removed using the reverse osmosis process.

Evaluating Effectiveness of Semiconductor Waste Water Recycling Processes

Various tests were performed to evaluate the efficiency with which waste water can be treated and recycled using the principles of the present invention. In a “Comparative Example,” semiconductor waste water was not pretreated, and the non-pretreated semiconductor waste water was then treated using a reverse osmosis.

In another example (referred to for convenience as the “Present Invention”) incorporating principles of the present invention, however, microbes in semiconductor waste water were removed using sodium hypochlorite (NaOCl) as a disinfectant. A chemical reaction between a carbonic acid gas and calcium was further prevented using hydrogen chloride (HCl). A weak acid cation ion exchange resin was then prevented from being oxidized using sodium bisulfate (NaHSO₄). The semiconductor waste water was then provided with sodium hydroxide (NaOH) to achieve a pH of about 9.0. Calcium and magnesium were also removed from the waste water using the weak acid cation ion exchange resin. The waste water was then provided with hydrogen chloride (HCl) to achieve a pH of approximately 2.0. Carbonic acid gas was next removed from the waste water. The pretreated semiconductor waste water was then provided with sodium hydroxide (NaOH) to acquire a pH of around 11.0. Organic carbon, silicon oxide, sodium, chlorine, sulfur, boron, etc., were then removed from the semiconductor waste water through a reverse osmosis process.

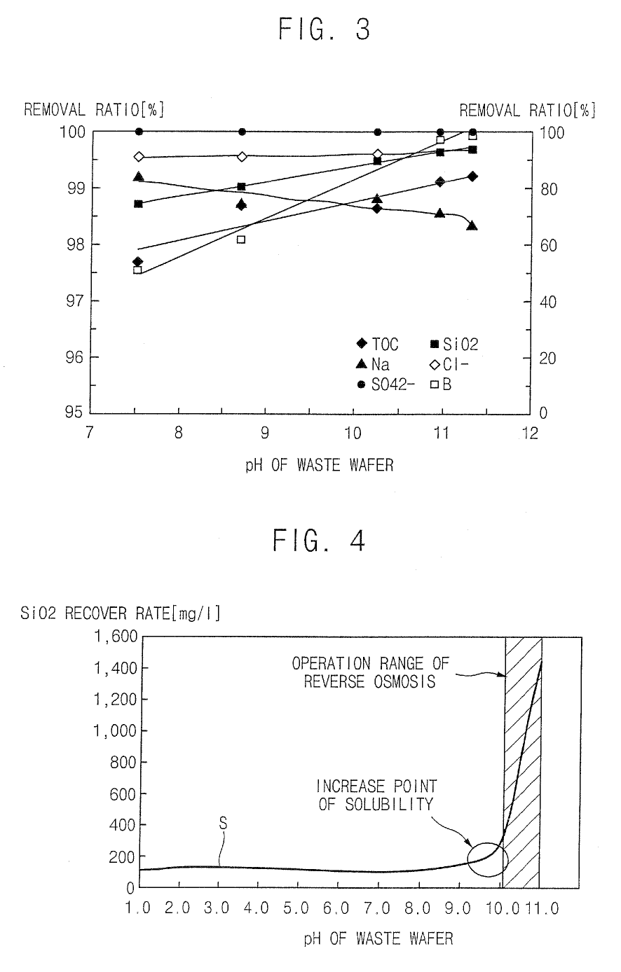

FIG. 3 is a graph illustrating removal ratios of noxious components in the waste water in accordance with a pH of the waste water. In FIG. 3, a vertical axis located on the right side of the graph represents a removal ratio of boron, while a vertical axis located on the left side of the figure indicates removal ratios of the total organic carbon (TOC), silicon oxide (SiO₂), sodium (Na), chlorine ion (Cl⁻), and sulfur oxide (SO₄²⁻). The horizontal axis represents a pH of the semiconductor waste water.

As shown in FIG. 3, it should be noted that the removal ratios of the organic carbon (TOC), the silicon oxide (SiO₂), the sodium (Na), the chlorine ion (Cl⁻), and the sulfur oxide (SO₄²⁻) are increased in proportion to an increase in the pH of the semiconductor waste water in a reverse osmosis unit. The semiconductor waste water in the reverse osmosis unit of the Comparative Example has a pH of 8. In contrast, according to the example of the Present Invention, since sodium hydroxide (NaOH) is put into the semiconductor waste water before it is supplied to the high-efficiency reverse osmosis unit, the semiconductor waste water has a pH of about 11. As a result, the example of the Present Invention removes the organic carbon, the silicon oxide (SiO₂), the sodium (Na), the chlorine ion (Cl⁻), and the sulfur oxide (SO₄²⁻) with increased efficiency as compared to that of Comparative Example.

FIG. 4 is a graph illustrating recover rates of silicon oxide from the waste water in accordance with a pH of the waste water. In FIG. 4, the vertical axis represents a recover rate (mg/t) of the silicon oxide, while the horizontal axis indicates a pH of the semiconductor waste water. A curved line S represents a solubility of the silicon oxide.

As shown in FIG. 4, when the pH of the semiconductor waste water passes about 10, the solubility of the silicon oxide rapidly increases. Thus, it should be noted that the example of the Present Invention, where the high-efficiency reverse osmosis unit is operated with a pH of about 11, has an improved recover rate of silicon oxide as compared to that of Comparative Example, where the high-efficiency reverse osmosis unit is operated at a pH of about 8.

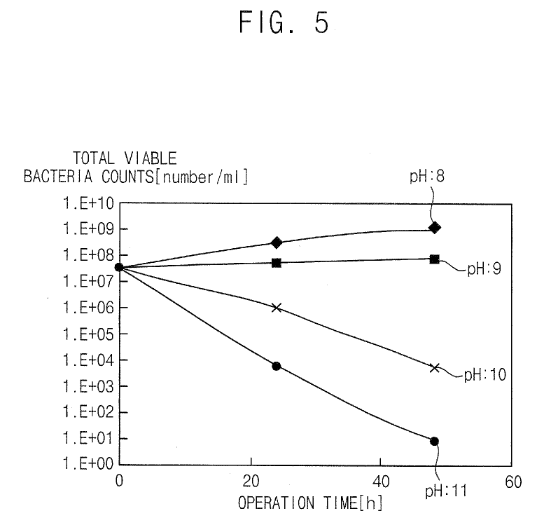

FIG. 5 is a graph illustrating total viable bacteria counts in the waste water in accordance with a pH of the waste water and an operation time of the reverse osmosis unit. In FIG. 5, the vertical axis represents a total viable bacteria count (count/ml), and the horizontal axis indicates an operation time of the reverse osmosis unit.

As shown in FIG. 5, when the pH of the semiconductor waste water is around 8, the total viable bacteria counts are increased regardless of the length of operation of the reverse osmosis unit. In contrast, when the pH of the semiconductor waste water is around 11, the total viable bacteria counts are increasingly reduced in proportion to the operation time of the reverse osmosis unit. Accordingly, it should be noted that the example of the Present Invention much more effectively removes bacteria from the semiconductor waste water as compared to the Comparative Example.

The following Table 1 summarizes various observed characteristics of industrial waters obtained using the Comparative Example and the example of the Present Invention, respectively.

TABLE 1

| | Comparative Example | Present Invention |
|---|---|---|
| TOC (ppm) | 0.5 | 0.07 |
| Transmissivity (μm/cm) | 95.8 | 99 |
| Ca (ppm) | 2.77 | 0.001 |
| Recover Rate (%) | 75 | 89 |
| Cost (won/m³) | 576 | 290 |

As can be seen from Table 1, an amount of the total organic carbon (TOC) remaining in the industrial water in the Comparative Example is 0.5 ppm. In contrast, the amount of the TOC remaining in the industrial water of the example of the Present Invention is only 0.07 ppm, which is significantly lower than in the Comparative Example. Further, the transmissivity of waste water in the Comparative Example is 95.8 μm/cm. In contrast, the transmissivity in the example of the Present Invention is 99 μm/cm, which is improved over that of the Comparative Example. An amount of calcium (Ca) remaining in the industrial water of the Comparative Example is 2.77 ppm. In contrast, an amount of Ca remaining in the industrial water according to the example of the Present Invention is a mere 0.001 ppm, which is again significantly lower than that of the Comparative Example. As a result of these improvements, the recover rate of the industrial water with respect to the semiconductor waste water in the example of the Present Invention is 89% as compared to the 75% recover rate in the Comparative Example. Thus, it can be seen that the principles of the present invention result in a recover rate that is significantly higher than that of the Comparative Example. And, of further significance, it costs less to recycle the waste water in the example of the Present Invention than in the Comparative Example.

According to principles of the present invention, recycled semiconductor waste water can be made available for use as industrial water for performing future semiconductor fabrication processes. Thus, a cost for manufacturing a semiconductor device can be reduced. Recycling waste water according to principles of the present invention is also more environmentally friendly than the conventionally used methods, since it produces less semiconductor waste water.

Having described the principles of the present invention with respect to various preferred embodiments thereof, it should be recognized that modifications and variations can be made by persons skilled in the art in light of the above teachings without departing from the principles thereof. It should therefore be further understood that changes may be made to the various embodiments of the present invention disclosed herein without departing from the scope and the spirit of the invention as outlined by the appended claims.

What is claimed is:

1. A method of recycling waste water, comprising:
removing a hardness from the waste water;
removing a gas from the waste water; and
removing salt and organic carbon from the waste water using high-efficiency reverse osmosis.

2. The method of claim 1, further comprising putting a disinfectant into the waste water to remove microbes from the waste water before removing the hardness.

3. The method of claim 2, wherein the disinfectant comprises sodium hypochlorite (NaOCl).

4. The method of claim 1, wherein removing the hardness comprises passing the waste water through an ion exchange resin to remove calcium (Ca) and magnesium (Mg) from the waste water.

5. The method of claim 4, wherein the ion exchange resin comprises a weak acid cation resin.

6. The method of claim 4, wherein removing the hardness comprises putting a neutralizing agent into the waste water to prevent an oxidation of the ion exchange resin.

7. The method of claim 6, wherein the neutralizing agent comprises sodium bisulfate (NaHSO₄).

8. The method of claim 4, wherein removing the hardness comprises putting a first pH-controlling agent into the waste water to provide the waste water with a pH of between about 8.5 to about 9.5.

9. The method of claim 8, wherein the first pH-controlling agent comprises sodium hydroxide (NaOH).

10. The method of claim 4, wherein removing the hardness comprises putting an anti-scale agent into the waste water.

11. The method of claim 10, wherein the anti-scale agent comprises hydrogen chloride (HCl).

12. The method of claim 1, wherein removing the gas comprises removing carbonic acid gas from the waste water.

13. The method of claim 12, wherein removing the carbonic acid gas comprises putting a second pH-controlling agent into the waste water to provide the waste water with a pH of between about 2 to about 3.

14. The method of claim 13, wherein the second pH-controlling agent comprises hydrogen chloride (HCl).

15. The method of claim 1, wherein removing salt and organic carbon comprises putting a third pH-controlling agent into the waste water to provide the waste water with a pH of no less than about 10.

16. The method of claim 15, wherein the third pH-controlling agent comprises sodium hydroxide (NaOH).

17. A method of recycling semiconductor waste water, comprising:
putting sodium hydroxide (NaOH) into the waste water to provide the semiconductor waste water with a pH of between about 8.5 to about 9.5;
passing the semiconductor waste water through a weak acid cation ion exchange resin to remove calcium (Ca) and magnesium (Mg) from the semiconductor waste water;
putting hydrogen chloride (HCl) into the semiconductor waste water to provide the semiconductor waste water with a pH of between about 2 to about 3;
removing carbonic acid gas from the semiconductor waste water;
putting sodium hydroxide (NaOH) into the semiconductor waste water to provide the semiconductor waste water with a pH of no less than about 10; and
removing salt and organic carbon from the semiconductor waste water using high-efficiency reverse osmosis.

18. The method of claim 17, further comprising putting sodium hypochlorite (NaOCl) into the semiconductor waste water to remove microbes from the semiconductor waste water before putting sodium hydroxide (NaOH) into the waste water to provide the semiconductor waste water with a pH of between about 8.5 to about 9.5.

19. The method of claim 17, further comprising putting sodium bisulfate into the semiconductor waste water to prevent an oxidation of the weak acid cation ion exchange resin before passing the semiconductor waste water through the weak acid cation ion exchange resin.

20. The method of claim 17, further comprising putting hydrogen chloride (HCl) into the semiconductor waste water to prevent scales from being formed on an inner wall of a pipe before passing the semiconductor waste water through the weak acid cation ion exchange resin.

21. An apparatus for recycling waste water, comprising:
a hardness-removing unit adapted to remove hardness from the waste water;
a gas-removing unit connected to the hardness-removing unit and adapted to remove a gas from the waste water; and
a high-efficiency reverse osmosis unit connected to the gas-removing unit to remove salt and organic carbon from the waste water.

22. The apparatus of claim 21, further comprising a first line communicating with a first pipe connected to the hardness removing unit, wherein the first line is configured to supply a disinfectant to the first pipe, wherein said disinfectant removes microbes from the waste water, and wherein the first pipe is configured to supply waste water into the hardness removing unit.

23. The apparatus of claim 21, wherein the hardness removing unit comprises a weak acid cation ion exchange resin for removing calcium (Ca) and magnesium (Mg) from the waste water.

24. The apparatus of claim 21, further comprising a second line configured to supply a neutralizing agent to the hardness removing unit to prevent an oxidation of the ion exchange resin.

25. The apparatus of claim 21, further comprising a third line configured to supply a first pH-controlling agent to the hardness removing unit to provide the waste water with a pH of between about 8.5 to about 9.5.

26. The apparatus of claim 21, further comprising a fourth line configured to supply an anti-scale agent to a pipe through which the waste water is introduced into the hardness removing unit to prevent scales from being formed on the pipe.

27. The apparatus of claim 21, further comprising a fifth line configured to supply a second pH-controlling agent to the gas-removing unit to provide the waste water in the gas-removing unit with a pH of between about 2 to about 3.

28. The apparatus of claim 21, further comprising a sixth line configured to supply a third pH-controlling agent into the reverse osmosis unit to provide the waste water in the reverse osmosis unit with a pH of no less than about 10.

29. The apparatus of claim 21, further comprising:
a first bath configured to store the waste water before supplying the waste water into the hardness removing unit;
a second bath configured to receive and store the waste water from the hardness removing unit;
a third bath configured to receive and store the waste water from the gas removing unit; and
a fourth bath configured to receive and store the waste water from the reverse osmosis unit.
